(19) United States
(12) Patent Application Publication
(10) Pub. No.: US 2024/0316604 A1
(43) Pub. Date: Sep. 26, 2024

(54) RINSING DEVICE

(71) Applicant: B/E Aerospace, Inc., Winston-Salem, NC (US)

(72) Inventors: Piotr Jacek Kroczek, Nieciszów (PL); Lukasz Turek, Wroclaw (PL)

(73) Assignee: B/E Aerospace, Inc., Winston-Salem, NC (US)

(21) Appl. No.: 18/584,796

(22) Filed: Feb. 22, 2024

(30) Foreign Application Priority Data
Mar. 22, 2023 (EP) 23461535.9

(51) Int. Cl. B08B 9/08; B08B 7/02

(52) U.S. Cl. CPC B08B 9/08; B08B 7/02; B08B 2209/08

(57) ABSTRACT

A rinse device comprising rinse device comprising a housing, and where in the housing there is provided: a rinse fluid dispensing mechanism configured to eject a rinse fluid from the housing into a volume surrounding the housing; and a pressure generating mechanism configured to generate pressure waves in the volume.

### CROSS-REFERENCE TO RELATED APPLICATIONS

This application claims priority to EP application Ser. No. 23/461,535.9, filed Mar. 22, 2023 and titled “RINSING DEVICE,” which is incorporated by reference herein in its entirety for all purposes.

### FIELD

The present disclosure relates to rinse devices using for cleaning the interior of a container or tank such as, but not exclusively, a waste tank e.g. in an aircraft.

### BACKGROUND

Tanks or reservoirs containing matter such as waste from a sanitation system or other matter which may be contaminated or hazardous or generally undesirable if left on the inner surfaces of the tank for a period of time often include a device that extends into and sprays water/water mist and/or some cleaning fluid around the tank to clean the tank. This can avoid the need for manual cleaning of the tank which can be unpleasant or even dangerous. Furthermore, the tanks are often too small to enable a person to access the interior to clean it properly, or the tank may be vacuum sealed and so not accessible for manual cleaning and/or access to the tanks may be too difficult for the tank to be cleaned by a person. Passenger aircraft include large tanks for human waste from the aircraft toilets. These tanks are emptied after a flight and the inside of the tank is cleaned. This is usually done by means of a device, known as a rinse nipple, having nozzles through which pressurized water or a cleaning solution is sprayed around the interior of the tank.

A conventional rinse nipple includes a housing part to which a rinse hose providing the cleaning fluid is connected. The housing extends through the tank wall at a rinse port. A rinse head is provided at the end of the housing located inside the tank. The rinse head is provided with multiple openings or nozzles and the pressurized fluid is ejected out through the nozzles to clean the tank. Some rinse nipples have a rotatable rinse head. To avoid the need for power to be supplied to rotate the rinse head, the openings or nozzles are angled and offset relative to the axis of rotation of the head. This positioning provides momentum about the axis to cause the head to spin about the axis thus maximizing the coverage of the fluid inside the tank.

Whilst the multiple nozzles and spinning head ensures that the fluid is sprayed as much as possible around the tank interior, due to the presence of various components and fittings that may be provided on the tank walls, extending to the tank interior, there may be some areas that are effectively obstructed or hidden by these components and are not reached by the spray from the spinning head. Furthermore, particularly when the tanks are large. The fluid may not reach the bottom of the tank, or may not reach the bottom with sufficient force to provide effective cleaning. This can result in waste material or the like remaining in those areas where the pressurized fluid does not reach, and clogging or building up. The tank cannot, therefore, be fully purged of all of the waste, which can cause contamination of the tank.

There is, therefore, a need for a rinse device that can ensure that a greater area of the tank interior is contacted by the spray of fluid.

### SUMMARY

According to the present disclosure, there is provided a rinse device comprising a housing, and wherein in the housing there is provided: a rinse fluid dispensing mechanism configured to eject a rinse fluid from the housing into a volume surrounding the housing; and a pressure generating mechanism configured to generate pressure waves in the volume.

A tank assembly and a cleaning method are also provided.

### BRIEF DESCRIPTION OF THE DRAWINGS

Examples of the rinse device according to this disclosure will be described with reference to the drawings. It should be noted that these are merely examples and variations are possible within the scope of the claims.

FIG. 1 shows an example of a known rinse device for the purposes of explanation;

FIG. 2 is shown to explain the problem of the known device such as shown in FIG. 1;

FIG. 3 shown an example of a tank to which a rinse device may be attached, for use in explaining the problems of the known devices;

FIG. 4 shows an example of a rinse fluid dispensing mechanism for dispensing a water mist into a tank;

FIG. 5 illustrates the operation of a mechanism such as shown in FIG. 4;

FIG. 6 is a 3D view of a rinse device in accordance with an example of this disclosure;

FIG. 7 is an exploded view of a device such as shown in FIG. 6;

FIG. 8 is view of the inside of a device such as shown in FIGS. 6 and 7;

FIGS. 9A and 9B illustrate an example of part of the mechanism of the device of FIGS. 6 to 8;

FIG. 10 is a 3D view of a rinse device in accordance with an alternative example of this disclosure;

FIG. 11 is an exploded view of a device such as shown in FIG. 10;

FIG. 12 is view of the inside of a device such as shown in FIGS. 10 and 11;

FIGS. 13A, 13B and 13C show details of part of the mechanism of the device of FIGS. 10 to 12; and

FIG. 14 is a schematic to illustrate the operation of a rinse device according to the disclosure.

### DETAILED DESCRIPTION

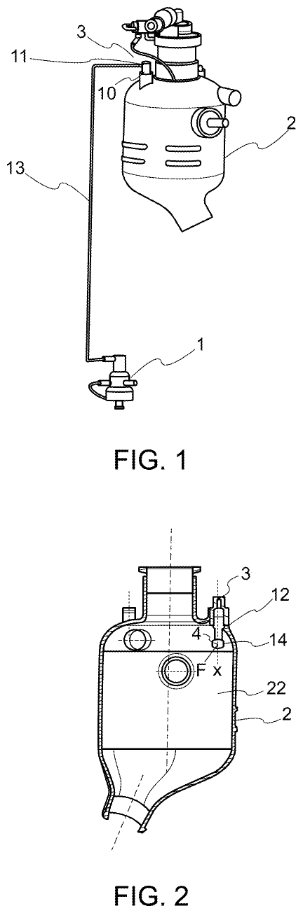

A typical rinse device is shown in FIGS. 1 and 2. A rinse nozzle 3 is shown mounted in the port 12 of a tank 2 or vat or other reservoir. The rinse nozzle 3 is connected, in use, to a rinse port 1 from which rinse fluid is provided to the rinse nozzle from a rinse fluid supply (not shown). FIG. 2 shows, in cross-section, the rinse nozzle 3 mounted in the port 12 of the tank 2, at the top of the tank. Apertures or jets 4 are formed in the nozzle 3 such that as rinse fluid is provided to the nozzle 3 it is sprayed out through the jets 4 around the interior 22 of the tank to clean the tank. A typical nozzle 3 comprises a housing 10, one end of which is provided with a fitting 11 arranged to be attached to a pipe or the like 13 via which pressurized water or cleaning solution is provided. At the other end of the housing through which the pressurized fluid flows, which extends into the tank, is mounted a rinse head 14 mounted to rotate relative to the housing 10. The rinse head is arranged to rotate about an axis of rotation X which is the axis through the housing from the one end to the other end.

The rinse head 14 is provided with a number of holes or jets 4 via which the pressurized fluid F forced through the housing is ejected into the tank. The jets can be positioned offset from the axis of rotation and at angles such that the ejection of the pressurized fluid F provides a force that causes the rinse head 14 to rotate relative to the housing about the axis X.

The pressurization of the fluid and the rotation of the rinse head provides a good range of coverage of the interior of the tank with cleaning fluid. In some cases, however, areas may exist, due to the presence of other components on the inside of the tank, that fluid from the rinse head cannot reach. Alternatively, because the rinse nozzle is typically small and mounted into the top of the tank, the pressurized fluid F may not adequately reach the bottom or other locations in the interior of the tank, or at least not with sufficient force to adequately clean the tank. Furthermore, as can be seen in FIG. 2, the jets do not clean the tank in a symmetrical manner.

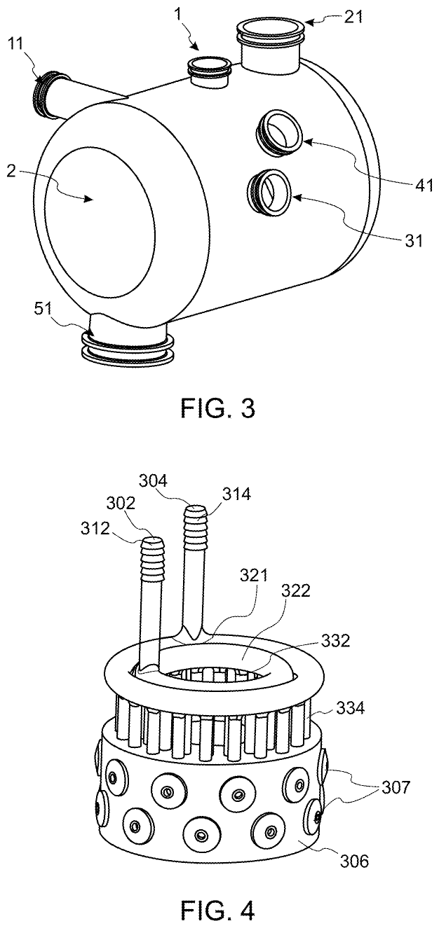

A typical tank 2 is shown in FIG. 3. In addition to the rinse port 1 to which the rinse device is attached as described above, further ports for mounting other devices may also be provided. The example of FIG. 3 shows a tank with an inlet port 11 through which the tank is filled with waste etc., a demister port 21 to which a demister device (not shown) may be fitted, a lower level (e.g. 70% full) sensor port 31 to which a level sensor (not shown) may be mounted to detect when the tank is, say, 70% full, a higher level (e.g. 100% full) sensor port 41 to which a level sensor (not shown) may be mounted to detect when the tank is, say, 100% full, and a drain valve port 51 to which a drain valve (not shown) may be mounted for selectively draining the tank. Once all of these devices are fitted to all of these ports, many obstructions may exist inside the tank to the fluid spray reaching all of the interior surface. It will also be difficult to clean the interior surfaces of the ports where the devices are mounted.

The rinse device according to this disclosure is designed to address these problems as will be described with reference to FIGS. 4 to 14.

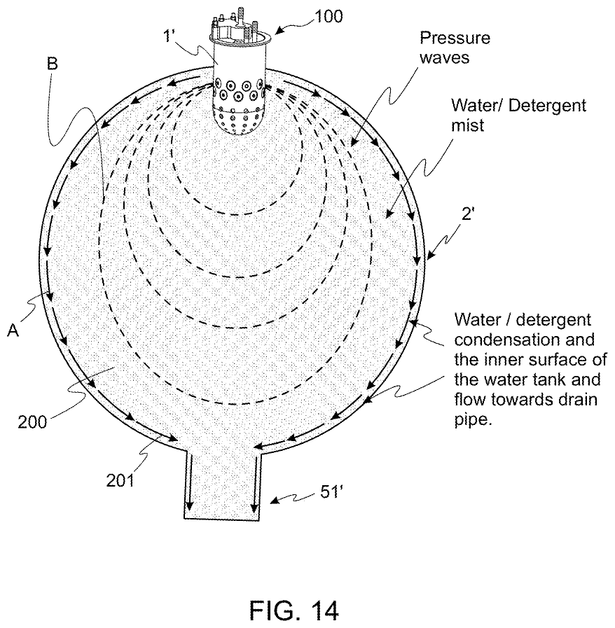

As will be described further below, with reference to specific, non-limiting examples, and with reference to FIG. 14, the rinse device of this disclosure has, within the rinse device housing that extends, in use, into the tank to be cleaned, a rinse fluid dispensing mechanism 300, 300′ that ejects rinse fluid from the rinse device housing into the tank interior volume 200, and a pressure wave generating mechanism 400, 400′ that generates pressure waves in the volume 200 to move the fluid around the interior volume and direct it around and against the interior surface or inner wall 201.

Reference is first made to FIG. 14 which shows, schematically, a rinse device 100 mounted to a tank 2′ at a rinse port 1′. The tank is also shown with a drain port 51′. The tank may be any known tank or, indeed, other container or reservoir, such as the tank described above, and will not be described in further detail. As is know in existing arrangements, the rinse device 100 extends into the volume 200 to be cleaned, the volume defined by an inner surface or wall 201 of the tank or other container. Again, as known, the rinse device ejects a rinse fluid through nozzles in the rinse device housing so that the fluid sprays out around the volume 200, ideally around the inner wall 201, to clean the container. In FIG. 14, the rinse fluid is a water/detergent mist as discussed further below, represented by arrows A. The pressure wave generating mechanism generates pressure waves represented by lines B in FIG. 14 which push the fluid towards the interior wall 201. The rinse fluid will flow, under gravity, from the wall down towards the bottom of the tank to the drain 51′.

The rinse device is preferably an elongate cylindrical device having a axis X through the device outer housing 310, 310′. The housing 310, 310′ is arranged to extend into the tank volume 200 when the rinse device is mounted to the tank 2′ (e.g. at a rinse port 1′). The rinse fluid dispensing mechanism and the pressure wave generating mechanism are mounted coaxially within the housing. Nozzle holes 312, 312′ are provided in the housing for ejection of the rinse fluid from the nozzles 307. 307′ into the volume. The housing is also provided with one or more openings 314, 314′ via which pressurized air is expelled to generate pressure waves in the volume as described further below.

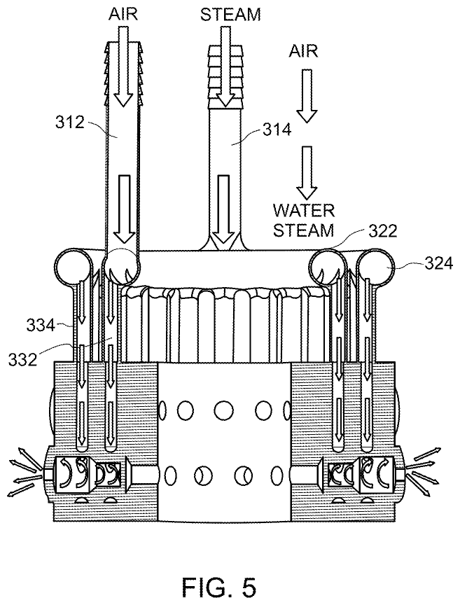

The rinse fluid may be water and/or detergent and/or a water/water-detergent mist sprayed out through nozzles 307, 307′. The rinse fluid may be provided in any known manner e.g. using a hose as described above. In the examples shown, the rinse fluid is in the form of a mist and the rinse fluid dispensing mechanism 300, 300′ comprises a low pressure air distribution system 302, 302′, a low pressure water steam distribution system 304 and a nozzle housing 306, 306′ on which are mounted spray nozzles 307, 307′. In the example shown, these components are mounted coaxially relative to axis X, with the low pressure air distribution system located within the low pressure water steam distribution system which is within the nozzle housing. The nozzles are arranged to coincide with the nozzle holes in the device housing. Other mechanisms arranged within the device housing for dispensing fluid through the nozzle holes can also be envisaged, but the example shown will now be described in more detail with reference to FIGS. 4 and 5.

As seen in FIG. 4, a low pressure rinse fluid dispensing mechanism can include a low pressure air distribution system 302 mounted coaxially with and inwardly of a low pressure water steam distribution system 304. Each system has a respective inlet 312, 314 fluidly connected to a respective manifold 322, 324 from which flow channels 332, 334 extend. The channels are in fluid communication with the nozzles 307 provided in the nozzle housing 306. In the example shown, there are two rows of multiple nozzles around the nozzle housing. This arrangement provides multiple source to introduce the low pressure spray quickly and efficiently into the volume.

FIG. 5 shows the fluid flow through the rinse fluid dispensing mechanism of this example. Air flows through the ‘AIR’ inlet 312 to the low pressure air distribution system manifold 322 and through the low pressure air distribution system channels 332 and the steam enters via the ‘STEAM’ inlet 314 through the channels 334 via the manifold 324. The air and steam are mixed at the nozzles 307 and are ejected from the nozzles 307 into the volume/tank 2′.

As the rinse fluid distribution system is low pressure, the problems discussed above of ensuring full coverage of the tank interior with rinse fluid, exist. The second part of the rinse device of this disclosure—the pressure wave generating mechanism 400, 400′—is configured to provide high pressure air to create waves in the volume to enhance movement of the rinse fluid/mist towards and against the wall defining the tank volume.

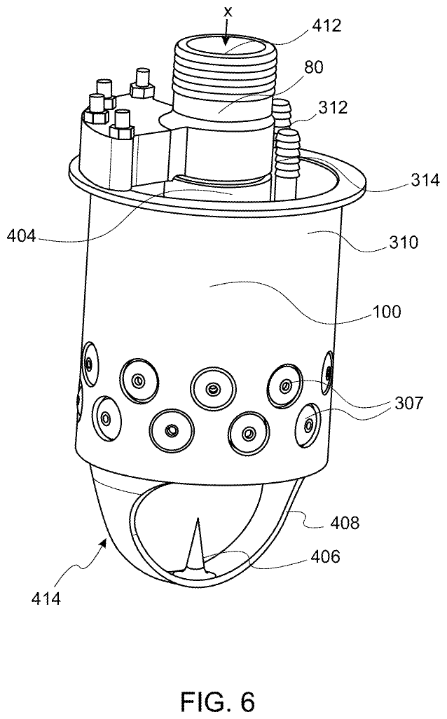

Various ways of generating pressure waves in the volume can be envisaged within the scope of the disclosure and two examples will be described in detail with reference to, respectively, FIGS. 6-9 and FIGS. 10 to 13. The common factor is that a high pressure mechanism is provided inside the device housing to generate the waves.

In the example shown in FIGS. 6 to 9, the pressure waves are created by introducing breakable bodies containing pressurized air to the mechanism. The mechanism is arranged to break these bodies to release the pressurized air into the volume when rinse fluid is introduced.

Specifically, in this example, the breakable bodies are in the form of hollow balls 402 filled with pressurized air, the pressure generating mechanism also includes a tube 404 into which the balls 402 are introduced from a first end 412. The tube 404 extends through the rinse device along axis X and, in the example shown, extends through, and coaxial with the rinse fluid dispensing device parts 302, 304, 306, all mounted within the housing 310.

The opposite end 414 of the tube 404 from the end where the balls are introduced is provided with a means for rupturing or fracturing the balls 402 as they reach the end of the tube. In the example shown, this is in the form of a spike 406 extending upwards from a cross-brace or bracket 408 spanning the end 414 of the tube. As the balls 402 are introduced into the tube and drop down the tube and hit the spike 406, the balls are broken due to the impact with the spike, internal pressure and kinetic energy from travelling down the tube, and thus release the pressurized air contained therein to create pressure waves B that propagate from the open end 314 of the housing into the volume 200.

This is just one example of the pressure generating mechanism. Similar mechanism may have bodies other than balls and the bodies may be ruptured by means other than a spike.

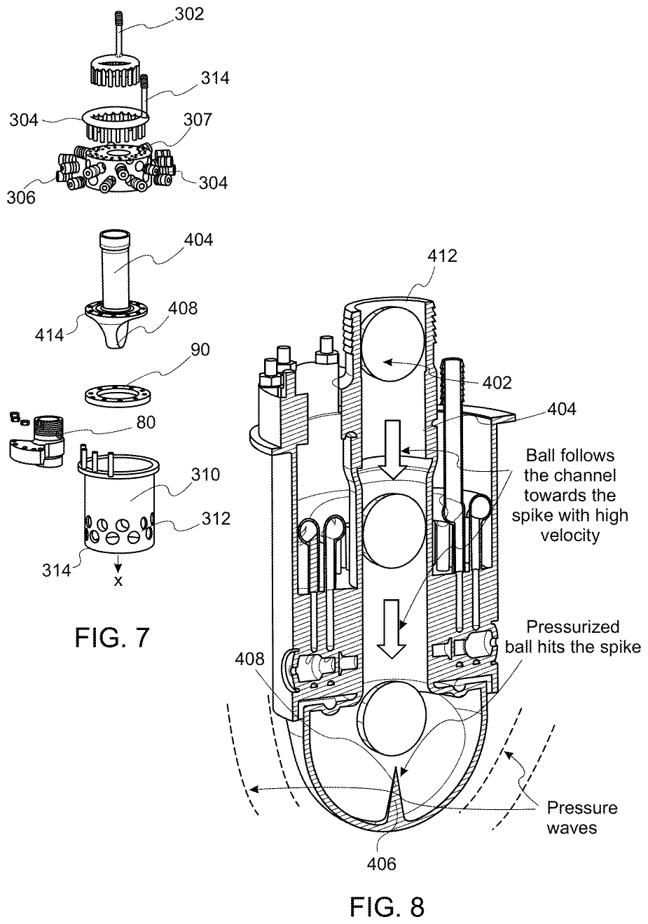

The structure described above is shown in its assembled form in FIG. 6 and in exploded form in FIG. 7.

The rinse fluid dispensing mechanism 300 and the pressure wave generating mechanism 400 may be fixed in relation to each other in the housing by means of a fixing block 80. A seal 90 may also be provided in the housing e.g. mounted on the tube 404.

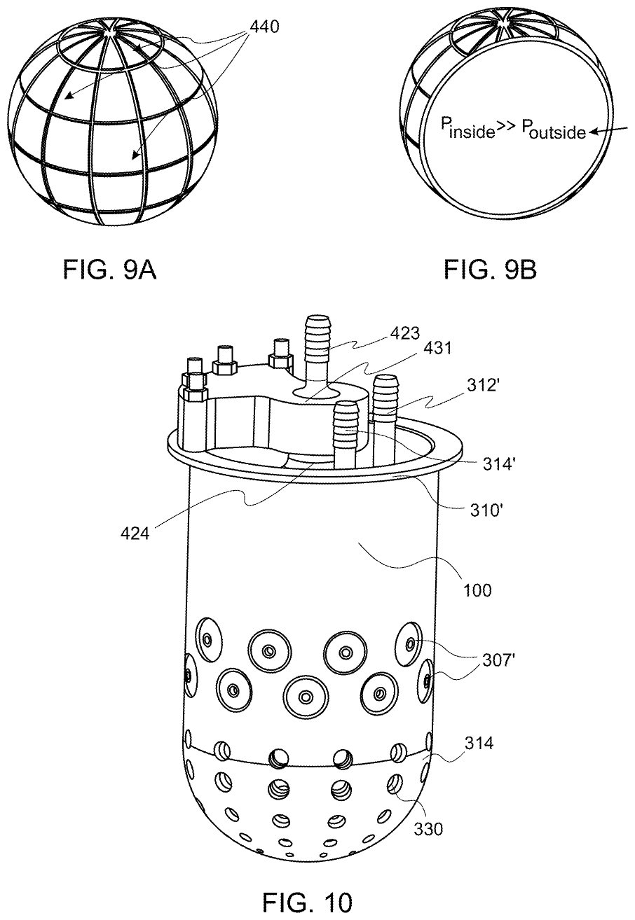

An example of balls 402 that may be used in a device according to the example just described is shown in FIGS. 9A and 9B. The balls may be made of a plastic or glass-type material and may be provided with lines of weakness 440 such that when the ball hits the spike 406 it breaks into multiple pieces at the lines of weakness, such that the pressure waves are released quickly.

An alternative pressure generation mechanism is described with reference to FIGS. 10 to 13.

In this example, the rinse fluid dispensing mechanism 300′ is as described above, having a low pressure air distribution system 302′, a low pressure water steam distribution system 304′ and nozzles 307′ mounted around a nozzle housing 406′ and which communicate with nozzle holes 312′ in the device housing 310′. The pressure generating mechanism 400′ in this example comprises an inner tube 424 which is filled with pressurized air (e.g. via a sealable inlet 423 at a first end 425 of the tube 424). The second end 427 is provided with a head 428 having a plurality of holes 429 formed therein. The head has a substantially hemispherical form. An outer seal 430 may be provided, shaped to fit around over the head 428. The seal 430 is also provided with a plurality of holes 432 preferably corresponding in size and number to the holes 429 in the head 428. In addition to performing a sealing function, the seal may position the inner tube 424 relative to the housing 310′. A rotating mechanism 434 is mounted between the housing 310′ and the tube to rotate the tube (by angle of rotation α) and, hence the head 428 and the seal 430 relative to the housing 310′. The housing 310′ is formed with a closed lower end 314′ which is shaped to accommodate the head and the seal and which is also provided with a plurality of holes 330 corresponding to the head holes 429.

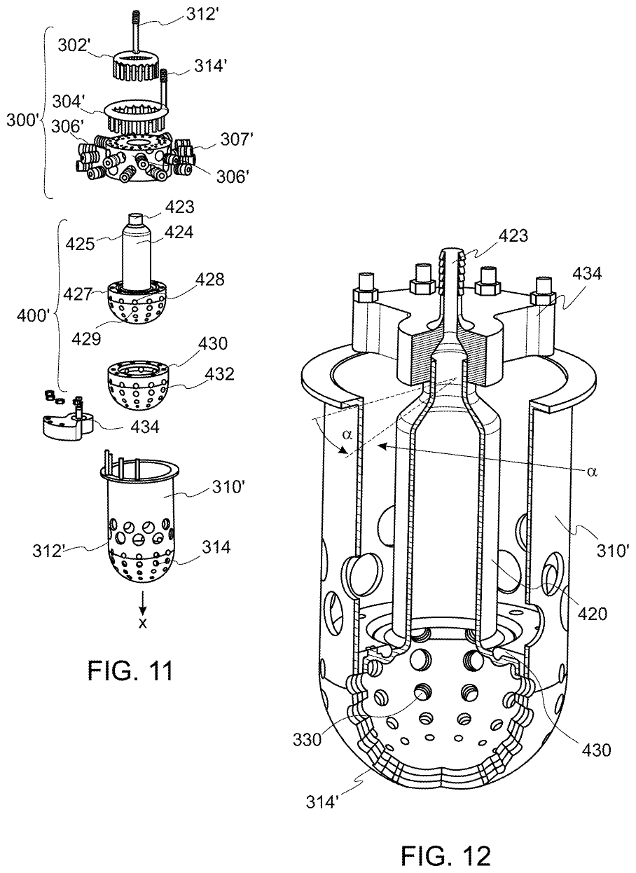

The second example is shown in assembled form in FIG. 10 and in exploded form in FIG. 11 and a cut-open view is seen in FIG. 12.

In use, the inner tube 424 is filled with high pressure air via the inlet 423. Where the seal 430 is provide, this is fitted over the head 428 at the end of the inner tube so as to move with the head. The holes in the seal are aligned with the holes in the head.

Initially, the rotation mechanism 434 is arranged such that the holes 429 in the head 428 do not align with/overlap the holes 330 in the closed end 314′ of the housing 310′. The body of the closed end therefore acts to close the holes of the head to prevent the pressurized air in the tube 424 from escaping via the head holes 429 into the volume. To release the pressurized air from the inner tube 424, e.g. when the rinse fluid is released into the tank 2′, the tube 424 and head 428 (and seal 430, where present) are rotated by the rotation mechanism 434 by angle α relative to the closed end 314′ such that the head holes align with/overlap the holes 330 in the housing 310 such that the air is released into the volume to generate pressure waves in the volume to move the rinse fluid as in the first example.

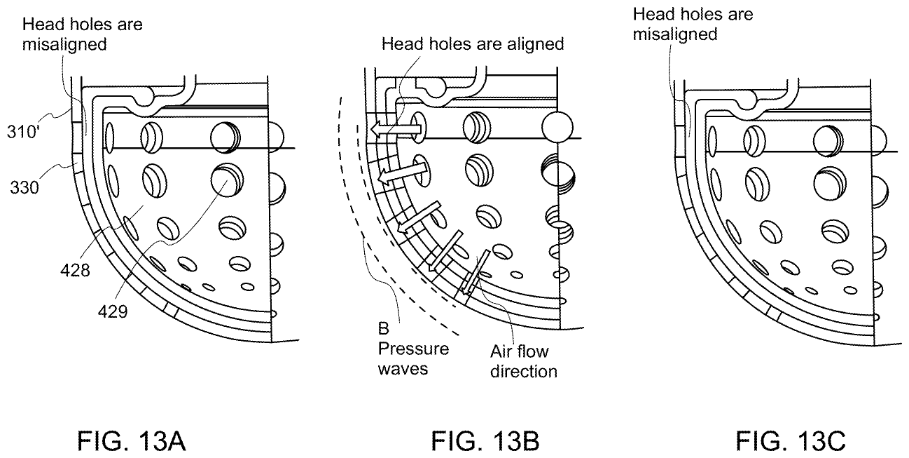

FIG. 13A shows the position where the head holes 428 are not aligned with the housing holes 330 and so no pressure wave is generated and the air is trapped within the inner tube 424. In the position shown in FIG. 13B, the head is rotated or tilted relative to the housing and the head holes and the housing holes are aligned, the air is released from the inner tube 424 and pressure waves B are generated in the volume. In FIG. 13C, the head has returned to the closed position relative to the housing. The head can be quickly rotated or tilted relative to the housing and the pressurized air is already stored in the inner tube 424 and so the pressure waves can be generated very quickly. The pressure waves are preferably generated by cycling the position between the open and closed position to pulse the air from the inner tube. Again, this is just one example of how pressure waves can be generated within the rinse device as the rinse fluid is ejected into the volume.

Referring back to FIG. 14, when the rinse fluid is dispensed into the tank volume 200 (e.g. once the volume is full or at some other time) the pressure wave generating mechanism is activated to generated waves of pressurized air in the volume 200. The waves spread towards the inner wall of the tank and provide momentum to the rinse fluid/mist droplets. The rinse fluid is thus forced towards the wall and at an increased pressure to provide effective cleaning over a large surface area of the wall. Spray fluid with high energy can reflect from any surface or obstacle inside the tank and continue to be moved in a turbulent manner around the volume. The fluid or mist that contacts (and cleans) the inner surface will then flow down the wall to the drain to remove the waste.

This arrangement provides an effective alternative to total flooding of the tank or intensive showering which may not effectively remove all debris, reaches more areas of the tank interior with increased pressure and also uses less water than known solutions.

1. A rinse device comprising rinse device comprising a housing, and where in the housing there is provided: a rinse fluid dispensing mechanism configured to eject a rinse fluid from the housing into a volume surrounding the housing; and a pressure generating mechanism configured to generate pressure waves in the volume.

2. The rinse device of claim 1, wherein the housing is provided with holes through which the rinse fluid is ejected.

3. The rinse device as claimed in claim 1, wherein the housing is provided with one or more openings through which pressurized air is released to generate the pressure waves in the volume.

4. The rinse device as claimed in claim 1, wherein the rinse fluid dispensing mechanism comprises a rinse fluid inlet and a plurality of nozzles via which the rinse fluid is ejected.

5. The rinse device as claimed in claim 4, wherein the rinse fluid dispensing mechanism comprises a low pressure air distribution system and a low pressure water steam distribution system in fluid communication with the plurality of nozzles to eject a water mist as the rinse fluid.

6. The rinse device as claimed in claim 1, wherein the housing is an elongate housing having an axis X and wherein the rinse fluid dispensing mechanism and the pressure generating mechanism are arranged coaxially relative to the axis, X, in the housing.

7. The rinse device as claimed in claim 1, wherein the pressure generating mechanism comprises a reservoir of pressurized air and means for releasing the pressurized air to generate the pressure waves in the volume.

8. The rinse device as claimed in claim 7, wherein the reservoir of pressurized air comprises a plurality of frangible bodies, optionally balls, filled with pressurized air and the means for releasing the pressurized air comprises means for rupturing the bodies.

9. The rinse device as claimed in claim 8, wherein the pressure generating mechanism comprises an inner tube through which the plurality of frangible bodies pass from a first, input end to a second end, and wherein the means for rupturing the bodies is located at the second end of the tube.

10. The rinse device as claimed in claim 9, wherein the means for rupturing comprises a spike positioned to impact and rupture the bodies as they exit the second end of the tube.

11. The rinse device as claimed in claim 7, wherein the reservoir of pressurized air comprises an inner tube filled with pressurized air and provided with a plurality of holes at an end thereof, and wherein the housing is provided with an end shaped to receive the end of the inner tube, the housing end being provided with a plurality of holes, and wherein the end of the tube is movable relative to the end of the housing between a closed position where the holes in the end of the inner tube are not aligned or overlapped with the holes in the housing end and a release position where the holes in the end of the tube are aligned or overlap with the holes in the end of the housing such as to release the pressurized air from the housing to generate the pressure waves in the volume.

12. The rinse device as claimed in claim 11, further comprising means to rotate or tilt the inner tube relative to the housing to move the end of the tube relative to the housing.

13. The rinse device as claimed in claim 12, further comprising a seal provided over the end of the tube, the seal having holes corresponding to the holes in the end of the tube.

14. A tank having a tank wall defining a tank interior volume, and the rinse device as claimed in claim 1, mounted to the tank such that the rinse device extends into the tank volume.

15. A method of cleaning the tank as claimed in claim 14, the method comprising providing a rinse fluid to the rinse fluid distribution mechanism, releasing the rinse fluid into the tank interior volume, and activating the pressure generating mechanism to generate pressure waves in the volume.
